(19) United States
(12) Patent Application Publication
(10) Pub. No.: US 2015/0345760 A1
(43) Pub. Date: Dec. 3, 2015

(54) Elastic Band Mount for Lighting Device

(71) Applicant: The Coleman Company, Inc., Wichita, KS (US)

(72) Inventors: Matthew G. Law, Wichita, KS (US); Nicole Birdsong, Denver, CO (US); Emily Donahue, Denver, CO (US)

(73) Assignee: The Coleman Company, Inc., Wichita, KS (US)

(21) Appl. No.: 14/725,485

(22) Filed: May 29, 2015

Related U.S. Application Data
(60) Provisional application No. 62/005,015, filed on May 30, 2014.

(51) Int. Cl. F21V 21/084; F21V 21/08; F21L 4/00

(52) U.S. Cl. CPC F21V 21/084; F21L 4/00; F21V 21/0816; F21W 2111/10

(57) ABSTRACT

A lighting device having an elastomeric band connected to the housing at a first side and surrounding the housing, the elastomeric band seated in a channel surrounding the housing in a first configuration, the elastomeric band removable from the channel and capable of wrapping around a structure to which the lighting device is to be secured, the elastomeric band hooking over a retention tab located on the housing on a side opposite the elastomeric band connection side to secure the lighting device to the structure.

### CROSS-REFERENCE TO RELATED APPLICATIONS

This application claims priority to U.S. Provisional Patent Application No. 62/005,015 filed May 30, 2014, which is incorporated by reference as if fully rewritten herein.

### FIELD OF INVENTION

The present invention generally relates to a lighting device and, more specifically, to a lighting device having an elastic band connected to the body of the lighting device and retained in a channel surrounding the body of the lighting device, the elastic band which can be secured around a pole, handlebar or other structure to retain the lighting device thereon.

### BACKGROUND OF THE INVENTION

Often times, a user of a light would like to attach the light to a specific structure for hands-free lighting. There are limited options available for attaching a light where a user needs it. Certain clips, clamps and hooks are commercially available for securing a light to a pole or elsewhere. Additionally, with respect to headlamps specifically, there are numerous headlamps which utilize the headlamp strap for securing the headlamp around a structure instead of to a user's head. Some people, however, do not want the strap that goes around their head to be used to secure the headlamp around a structure as such use can stretch out the strap or otherwise make the strap undesirable for placement around the head. Other headlamps utilize lanyards or carabiner clips for attachment to a structure. These attachment methods, however, require separate devices for attachment. What is needed is an integrated attachment solution for a lighting device and more particularly for a headlamp which allows for mounting of the light to several different structures.

### SUMMARY OF THE INVENTION

The current proposed invention provides a lighting device having a housing, the housing having a channel surrounding the light emitting portion of the housing, an elastic band attached to the housing at a first side, the elastic band residing in the channel in a first configuration, and a retention tab located on the side opposite the elastic band attachment point. In a second configuration, the elastic band does not reside in the channel but passes around a structure on the backside of the lighting device, the free side of the elastic band being secured around the retention tab, the lighting device thereby being secured to the structure and the light emitting portion of the lighting device functioning to emit light and not be blocked by the structure to which it is attached.

### BRIEF DESCRIPTION OF THE FIGURES

FIG. 1 shows a bottom perspective view of a lighting device, specifically a headlamp, of the present invention;

FIG. 2 shows a right side view of the headlamp of FIG. 1 shown without the headlamp head strap and shown in a first configuration in an inverted orientation;

FIG. 3 shows a top view of the headlamp of FIG. 1, shown without the headlamp head strap;

FIG. 4 shows a right side view of the headlamp of FIG. 1, shown without the headlamp head strap and shown with the elastomeric member disengaged from the channel in an inverted orientation;

FIG. 5 shows a bottom view of the headlamp of FIG. 1, shown without the headlamp head strap and shown in a second configuration with the headlamp secured around a structure.

FIG. 6 shows a right side view of the headlamp of FIG. 1, shown without the headlamp head strap and shown in a second configuration with the headlamp secured around a structure;

FIG. 7 shows a right side view of the headlamp of FIG. 6, shown in the second configuration without the structure.

### DETAILED DESCRIPTION OF THE INVENTION

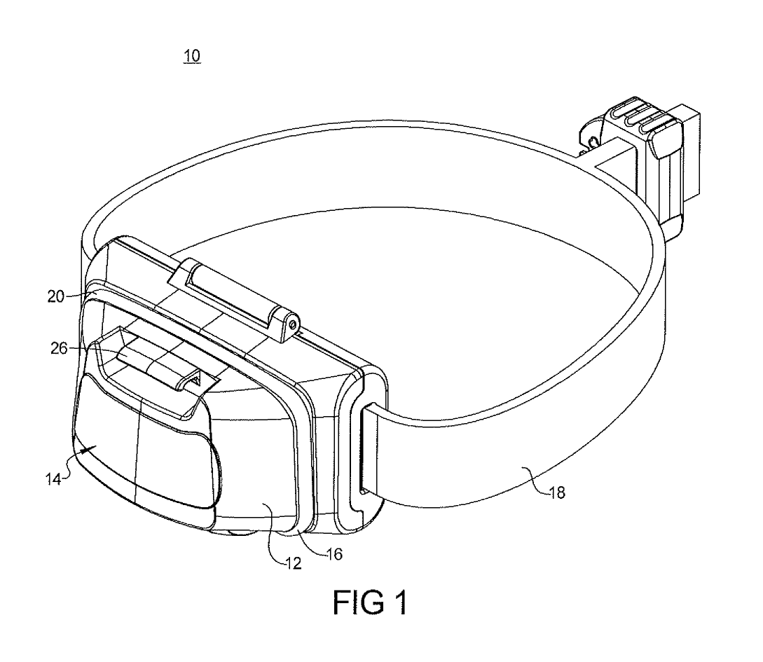

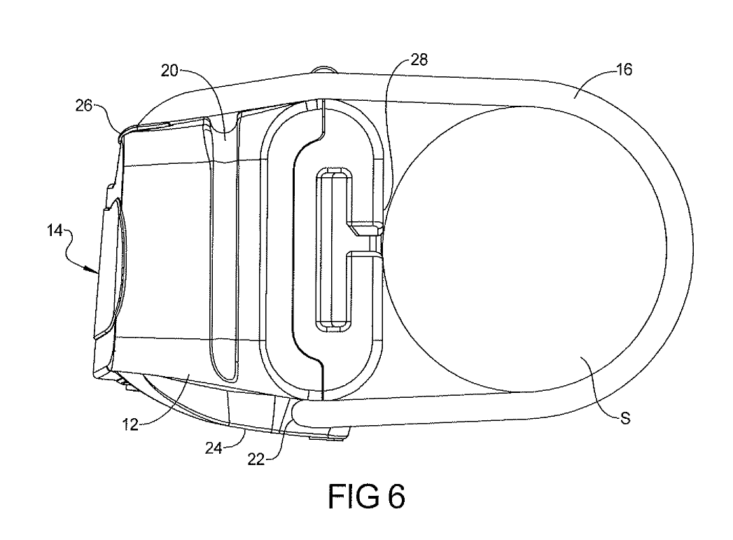

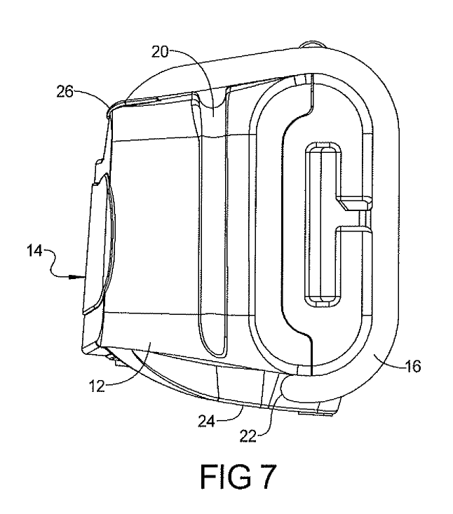

As shown in FIGS. 1-7, lighting device 10 comprises a housing 12 having a light emitting lamp portion 14. Although not shown, lighting device 10 also comprises a bulb and an operably connected power source as is commonly known in the industry, the general structure of which will not be repeated here. The preferred lighting device 10 shown is a headlamp. Lighting device 10 further comprises head strap 18 which is connected to housing 12 by means commonly known and used in the industry. The general structure and functioning of the lighting device is not the focus of the present invention. The present invention relates to the elastomeric member surrounding the housing 12 and residing in the channel 20 as will be described in greater detail below.

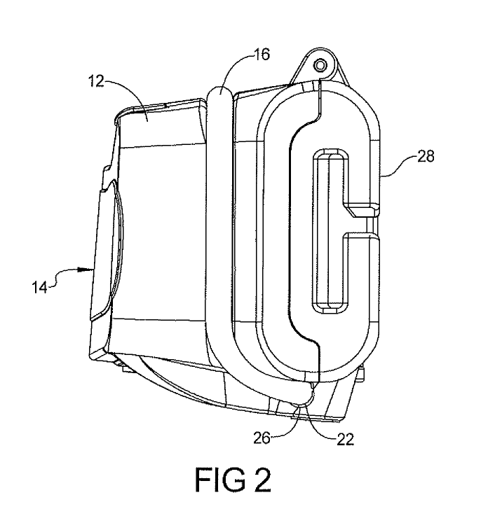

In a first configuration shown in FIGS. 1 and 2, elastomeric band 16 resides in channel 20 which surrounds the perimeter of housing 12 on at least two and preferably three sides. Elastomeric band 16 is connected to housing 12 at a first side of housing (where preferably no channel is present) at connection locus 22, preferably located on the top side of lighting device 10. Elastomeric band 16 is placed on the first side of housing 12 during manufacture and cover piece 24 is placed over elastomeric band 16 and connected to housing 12 to secure the elastomeric band to the housing. Various methods of connection known and used in the industry are within the scope of the present invention. Elastomeric band 16 is made of elastomeric material and forms a closed loop which is sized to fit snugly around housing 12 perimeter and within channel 20 diameter.

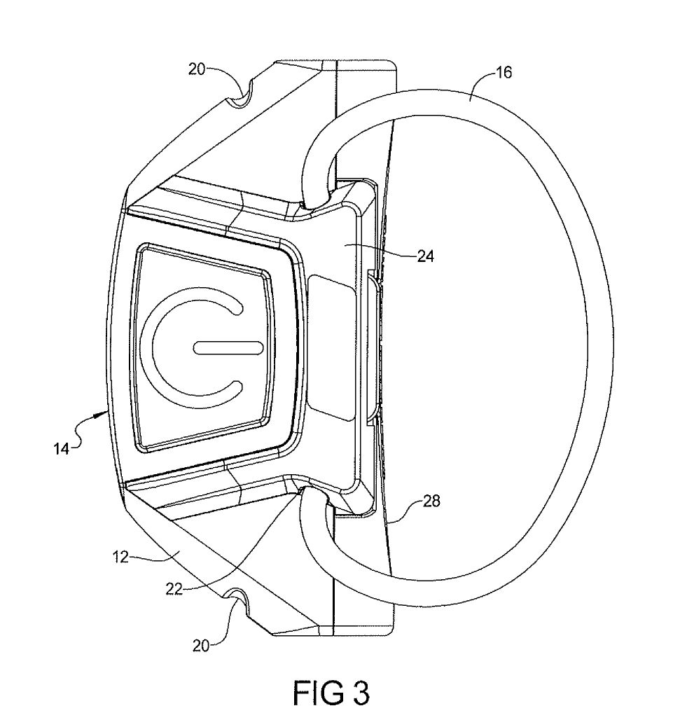

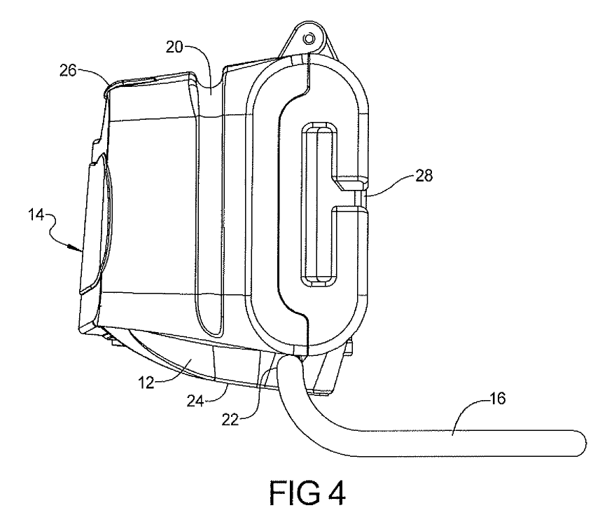

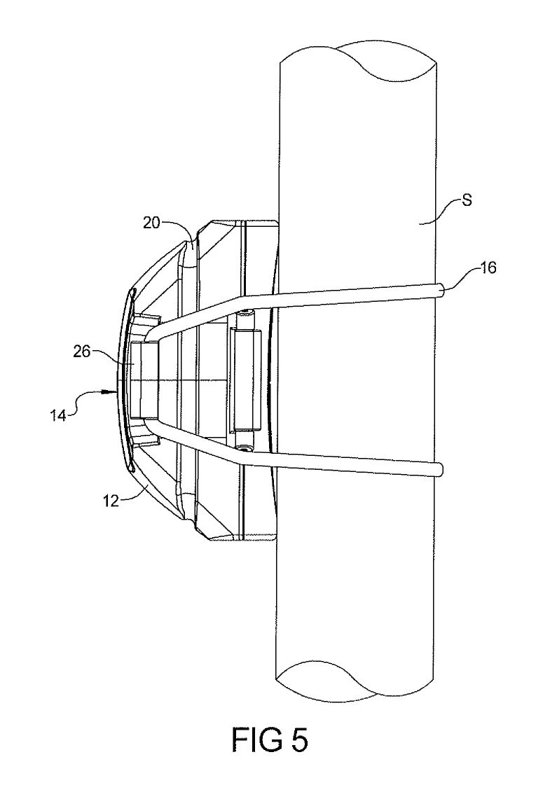

Lighting device 10 further comprises retention tab 26 located on a second side of the housing 12 which is opposite the side where connection locus 22 is located. In use, a user desiring to secure lighting device 10 to a structure S would take lighting device 10 in its first configuration and unseat elastomeric band 16 from channel 20 (shown in FIGS. 3 and 4), place the backside 28 of lighting device 10 on the desired structure S, wrap elastomeric band 16 around structure S and secure elastomeric band 16 around retention tab 26, thus securing lighting device 10 to structure S in a second configuration. In the second configuration, shown in FIGS. 5-7, the light emitting portion 14 of lighting device 10 functions to emit light as intended and is generally not blocked by the structure S.

The structure S to which lighting device 10 can be secured will vary in size depending on the size of housing 12 and length of elastomeric band 16. Although the general shape of the structure S to which the lighting device 10 is secured is preferably a cylinder such as a tube, tree, pole or bicycle handlebar, other shapes are within the scope of the present invention such a structures having triangular, square or other cross sectional shapes.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined by the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e. meaning “including, but not limited to”) unless otherwise noted. The term “connected” is to be construed as partly or wholly contained within, attached to or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A lighting device, comprising:
A housing;
A light emitting lamp residing within said housing;
A power source electrically connected to said light emitting lamp and providing power thereto;
An elastomeric member connected to said housing;
A channel surrounding the perimeter of said housing, said channel sized to retain said elastomeric member;
A retaining member located opposite the location of said elastomeric member connection to said housing;
In a first configuration, said elastomeric member seated within said channel and surrounding said housing; and
In a second configuration, said elastomeric member unseated from said channel and capable of extending around an object to which said lighting device is to be secured, said elastomeric member retained on the housing by retaining member.

2. The lighting device of claim 1, wherein said elastomeric member is connected to said housing at a top side of said housing.

3. The lighting device of claim 1, wherein said retaining member comprises a tab extending from the housing over which elastomeric member may be placed and secured.

4. The lighting device of claim 1, wherein said lighting device is a headlamp, said headlamp further comprising a strap connected to said housing and allowing for retention of said headlamp about a user's head.
